(19) United States
(12) Patent Application Publication
(10) Pub. No.: US 2003/0224959 A1
(43) Pub. Date: Dec. 4, 2003

(54) Detergent system

(75) Inventor: David John Smith, Hett (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/444,705

(22) Filed: May 23, 2003

(30) Foreign Application Priority Data
May 24, 2002 (EP) 02253686.6

(51) Int. Cl. C11D 17/00

(52) U.S. Cl. 510/295; 510/447; 510/296; 510/439

(57) ABSTRACT

The present invention relates to a detergent system comprising a plurality of pre-formed subunits wherein at least one of the subunits is a liquid, paste or gel-filled water-soluble capsule or pouch and wherein the subunits are packaged together in a water-soluble film wrap.

The present invention also relates to a method of manufacture and a method of cleaning using said detergent system.

### CROSS REFERENCE TO RELATIONED APPLICATIONS

This application claims the benefit of the filing date of EPO patent application serial no. 02253686.6, filed May 24, 2002.

### FIELD OF THE INVENTION

The present invention is in the field of detergency in particular it relates to a detergent system in unit-dose form comprising a plurality of pre-formed subunits packaged together in a water-soluble film wrap.

### BACKGROUND TO THE INVENTION

Laundry and dishwashing detergent products can be found on the market to date in various forms, such as solid granular compositions and tablets, or liquid compositions. This gives the consumer a choice of detergent products they can use.

Some detergent ingredients currently used, are typically manufactured and processed in solid form, for example because these ingredients are water-insoluble and are difficult or costly to include in a liquid detergent composition, or because these materials are typically transported and supplied in solid form and therefore require extra processing steps to enable them to be included in a liquid detergent composition. Such detergent ingredients include water insoluble builders such as zeolites which can be included in liquid detergent compositions but only in limited amounts typically less than 20%. Also, certain ingredients are formed into granular form and supplied and processed in solid form for stability reasons, for example certain enzyme prills.

Conversely, some detergent ingredients currently used, are typically manufactured and processed in liquid form. These liquid ingredients are difficult or costly to include in a solid detergent composition. Also, certain ingredients are typically transported and supplied to detergent manufacturers in a liquid form and require additional, and sometimes costly, process steps to enable them to be included in a solid detergent composition. An example of these detergent ingredients are surfactants, especially nonionic surfactants which are often liquid at room temperature or are typically transported and supplied to detergent manufacturers in liquid form.

Therefore, to minimise the cost of a formulation it is desirable to have a detergent system comprising both solid and liquid components. In addition, having both solid and liquid components allows for maximum efficiency of the detergent system since certain ingredients are more efficient when delivered as solids (e.g. insoluble or soluble builders) and certain ingredients when delivered as a liquid (e.g. surfactants as you can deliver much higher levels).

### SUMMARY OF THE INVENTION

The present invention relates to a detergent system in unit-dose form comprising a plurality of pre-formed subunits wherein at least one of the subunits is a liquid, paste or gel-filled water-soluble capsule or pouch and wherein the subunits are packaged together in a water-soluble film wrap. The pre-formed subunits can be complete detergent compositions or components of detergent compositions which can, be combined together to form a complete detergent composition. The subunits are independently formed and afterwards enclosed together by a flow wrap. The subunits can be solid or liquid, paste or gel but preferably one of the subunits is a solid composition in the form of a tablet.

The system of the present invention, especially in the case of one of the subunits being a solid composition in the form of a tablet, allows for maximum detergent efficacy and formulation flexibility while minimising the material and/or equipment costs associated with such a system. Tablet manufacture equipment and flow wrapping facilities are easily available to the detergent manufacturer, the present invention allows for use of traditional systems offering new benefits namely the elimination of unwrapping the detergent product before it is used and at the same time the elimination of the contact of the consumer skin with the detergent product providing maximum convenience of use.

Detergent systems comprising a solid composition in the form of a tablet and a liquid, paste or gel-filled water-soluble capsule or pouch subunit present the known advantages of tablets, such as high product density, minimum storage volume requirements and efficient packing and additionally it also allows for the simultaneous or sequential release of a liquid, gel or paste in quantities which it would be impossible to achieve through normal tabletting techniques. Additionally these systems allow for some degree of flexibility favoring the fitting of the product in the dispenser, especially in the case of automatic dishwashing.

From the manufacturing viewpoint, detergent systems comprising a particulate automatic dishwashing product in the form of a tablet instead of in powder form are very convenient because they avoid the need to dose and pack the powder, a process which can be complex and prone to inaccuracies. Also, the process is often slow and likely to produce dust, such that it can be very difficult to avoid dust deposition on the wrapping material. This can be detrimental to achieving a strong seal.

The present invention also relates to a method of making and using a detergent system comprising a plurality of pre-formed subunits including at least one liquid, paste or gel-filled water-soluble capsule or pouch subunit wherein the subunits are packaged together in a water-soluble film wrap.

### DETAILED DESCRIPTION OF THE INVENTION

The system of the present invention includes as components, a plurality of pre-formed subunits wherein at least one of the subunits is a liquid, paste or gel-filled water-soluble capsule or pouch and a water-soluble film wrap. The number of subunits can vary, however systems with two subunits are preferred from a manufacturing view point. Systems with more than two subunits are also envisaged herein. These systems are not only valuable for the separation of incompatible detergent ingredients but also for the sequential release of different components.

Preferred systems resulting from the combination of a plurality of subunits, are designed for use as cleaning or fabric care products, preferably laundry or dish washing products.

Typically, the systems herein comprise an amount of a cleaning composition, such that one or more unit-doses is sufficient for a single wash. The detergent systems can also includes finishing compositions such as rinse compositions in the case of automatic dishwashing.

The present system can comprise a tablet and a capsule or pouch packaged side-by-side in a film wrap or, preferably, a capsule or pouch on top of a tablet and in contact therewith. To facilitate this the tablet can be pressed so that there is a depression on the top face where the pouch is placed prior to co-wrapping.

The compositions herein can comprise a variety of ingredients. Some ingredients are preferentially added to the solid compositions and some are preferentially added to the liquid. Preferably at least one and more preferably both compositions comprise at least one surfactant which in preferred embodiments is a non-ionic surfactant.

### Solid Composition

The present invention preferably comprises at least one solid detergent composition, preferably in the form of a tablet. Preferably the solid component comprises ingredients that are either difficult or costly to include in a substantially liquid composition or that are typically transported and supplied as solid ingredients and which would require additional processing steps to enable them to be included in a substantially liquid composition.

The tablet can be formed using any suitable method, but preferably by compression, for example in a tablet press. Preferably, the tablet is a compressed shaped body prepared by mixing together the components of the automatic detergent, for example a dishwashing or laundry detergent composition, followed by applying a compression pressure of at least about 40 kg/cm², preferably at least about 250 kg/cm², more preferably at least about 350 kg/cm² (3.43 kN/cm²), even more preferably from about 400 to about 2000, and especially from about 600 to about 1200 kg/cm² (compression pressure herein is the applied force divided by the cross-sectional area of the tablet in a plane transverse to the applied force—in effect, the transverse cross-sectional area of the die of the press). Such tablets being preferred herein from the viewpoint of providing optimum tablet integrity and strength (measured for example by the Child Bite Strength [CBS] test) and product dissolution characteristics. The tablets preferably have a CBS of at least about 6 kg, preferably greater than about 8 kg, more preferably greater than about 10 kg, especially greater than about 12 kg, and more especially greater than about 14 kg, CBS being measured per the US Consumer Product Safety Commission Test Specification.

The tablet can take a variety of geometric shapes such as spheres, cubes, etc but preferably has a generally axially-symmetric form with a generally round, square or rectangular cross-section.

The tablet can be prepared such that it comprises at least one mould in its surface. The mould or moulds can also vary in size and shape and in their location, orientation and topology relative to the tablet. For example, the mould or moulds can be generally circular, square or oval in cross-section; they can form an internally-closed cavity, depresion or recess in the surface of the tablet, or they can extend between unconnected regions of the tablet surface (for example axially-opposed facing surfaces) to form one or more topological ‘holes’ in the tablet; and they can be axially or otherwise symmetrically-disposed relative to the tablet or they can be asymmetrically disposed. Preferably, the mould is preformed, for example being created using a specially designed tablet press wherein the surface of the punch that contacts the detergent composition is shaped such that when it contacts and presses the detergent composition it presses a mould, or multiple moulds into the detergent tablet. Preferably, the mould will have an inwardly concave or generally concave surface to provide improved housing and physical storage of the liquid, gel or paste containing compartment. Alternatively, the mould can be created by compressing a preformed body of detergent composition disposed annularly around a central insert, thereby forming a shaped body having a mould in the form of a cavity extending axially between opposing surfaces of the body. Tablets with moulds are very useful from the viewpoint of accommodating the compartment comprising the anhydrous liquid, gel or paste dishwashing or laundry detergent auxiliary compositions.

The solid composition preferably comprises at least one ingredient selected from builder, bleaching system, enzyme, suds suppressor, and mixtures thereof.

Surfactant

In the systems of the present invention, the detergent surfactant is preferably low foaming by itself or in combination with other components (i.e. suds suppressers). Surfactants suitable herein include anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, preferably C₁₀-C₁₈ linear or branched; cationic surfactants such as chlorine esters (U.S. Pat. No. 4,228,042, U.S. Pat. No. 4,239,660 and U.S. Pat. No. 4,260,529) and mono C₆-C₁₆ N-alkyl or alkenyl ammonium surfactants wherein the remaining N positions are substituted by methyl, hydroxyethyl or hydroxypropyl groups; low and high cloud point nonionic surfactants and mixtures thereof including nonionic alkoxylated surfactants (especially ethoxylates derived from C₆-C₁₈ primary alcohols), ethoxylated-propoxylated alcohols (e.g., Olin Corporation's Poly-Tergent®) SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich.; amphoteric surfactants such as the C₁₂-C₂₀ alkyl amine oxides (preferred amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414 549, WO-A-93/08876 and WO-A-93/08874. Surfactants are typically present at a level of from about 0.2% to about 30% by weight, more preferably from about 0.5% to about 10% by weight, most preferably from about 1% to about 5% by weight of composition. Preferred surfactant for use herein are low foaming and include low cloud point nonionic surfactants and mixtures of higher foaming surfactants with low cloud point nonionic surfactants which act as suds suppresser therefor.

Builder

Builders suitable for use in detergent and cleaning compositions herein include water-soluble builders such as citrates, carbonates and polyphosphates e.g. sodium tripolyphosphate and sodium tripolyphosphate hexahydrate, potassium tripolyphosphate and mixed sodium and potassium tripolyphosphate salts; and partially water-soluble or insoluble builders such as crystalline layered silicates (EP-A-0164514 and EP-A-0293640) and aluminosilicates inclusive of Zeolites A, B, P, X, HS and MAP. The builder is typically present at a level of from about 1% to about 80% by weight, preferably from about 10% to about 70% by weight, most preferably from about 20% to about 60% by weight of composition.

Amorphous sodium silicates having an SiO₂:Na₂O ratio of from 1.8 to 3.0, preferably from 1.8 to 2.4, most preferably 2.0 can also be used herein although highly preferred from the viewpoint of long term storage stability are compositions containing less than about 22%, preferably less than about 15% total (amorphous and crystalline) silicate.

Enzyme

Enzymes suitable herein include bacterial and fungal cellulases such as Carezyme and Celluzyme (Novo Nordisk A/S); peroxidases; lipases such as Amano-P (Amano Pharmaceutical Co.), M1 Lipase^{R} and Lipomax^{R} (Gist-Brocades) and Lipolase^{R} and Lipolase Ultra^{R} (Novo); cutinases; proteases such as Esperase^{R}, Alcalase^{R}, Durazym^{R} and Savinase^{R} (Novo) and Maxatase^{R}, Maxacal^{R}, Properase^{R} and Maxapem^{R} (Gist-Brocades); and (α and β amylases such as Purafect Ox Am_{R} (Genencor) and Termamyl^{R}, Ban^{R}, Fungamyl^{R}, Duramyl^{R}, and Natalase^{R} (Novo); and mixtures thereof. Enzymes are preferably added herein as prills, granulates, or cogranulates at levels typically in the range from about 0.0001% to about 2% pure enzyme by weight of composition.

Bleaching Agent

Bleaching agents suitable herein include chlorine and oxygen bleaches, especially inorganic perhydrate salts such as sodium perborate mono-and tetrahydrates and sodium percarbonate optionally coated to provide controlled rate of release (see, for example, GB-A-1466799 on sulfate/carbonate coatings), preformed organic peroxyacids and mixtures thereof with organic peroxyacid bleach precursors and/or transition metal-containing bleach catalysts (especially manganese or cobalt). Inorganic perhydrate salts are typically incorporated at levels in the range from about 1% to about 40% by weight, preferably from about 2% to about 30% by weight and more preferably from abut 5% to about 25% by weight of composition. Peroxyacid bleach precursors preferred for use herein include precursors of perbenzoic acid and substituted perbenzoic acid; cationic peroxyacid precursors; peracetic acid precursors such as TAED, sodium acetoxybenzene sulfonate and pentaacetylglucose; pernonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP-A-0170386); and benzoxazin peroxyacid precursors (EP-A-0332294 and EP-A-0482807). Bleach precursors are typically incorporated at levels in the range from about 0.5% to about 25%, preferably from about 1% to about 10% by weight of composition while the preformed organic peroxyacids themselves are typically incorporated at levels in the range from 0.5% to 25% by weight, more preferably from 1% to 10% by weight of composition. Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes(U.S. Pat. No. 4,810,410).

Low Cloud Point Non-Ionic Surfactants and Suds Suppressers

The suds suppressers suitable for use herein include nonionic surfactants having a low cloud point. “Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362). As used herein, a “low cloud point” nonionic surfactant is defined as a nonionic surfactant system ingredient having a cloud point of less than 30° C., preferably less than about 20° C., and even more preferably less than about 100 C., and most preferably less than about 7.5° C. Typical low cloud point nonionic surfactants include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants include, for example, ethoxylated-propoxylated alcohol (e.g., Olin Corporation's Poly-Tergent® SLF18) and epoxy-capped poly(oxyalkylated) alcohols (e.g., Olin Corporation's Poly-Tergent® SLF18B series of nonionics, as described, for example, in U.S. Pat. No. 5,576,281).

Preferred low cloud point surfactants are the ether-capped poly(oxyalkylated) suds suppresser having the formula:

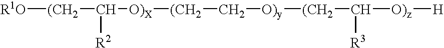

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula:

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:

(i) a 4 to 8 membered substituted, or unsubstituted heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms;

(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C, to C₅ alkyl.

Other suitable components herein include organic polymers having dispersant, anti-redeposition, soil release or other detergency properties invention in levels of from about 0.1% to about 30%, preferably from about 0.5% to about 15%, most preferably from about 1% to about 10% by weight of composition. Preferred anti-redeposition polymers herein include acrylic acid containing polymers such as Sokalan PA30, PA20, PA15, PA10 and Sokalan CP10 (BASF GmbH), Acusol 45N, 480N, 460N (Rohm and Haas), acrylic acid/maleic acid copolymers such as Sokalan CP5 and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol and mixtures thereof.

Heavy metal sequestrants and crystal growth inhibitors are suitable for use herein in levels generally from about 0.005% to about 20%, preferably from about 0.1% to about 10%, more preferably from about 0.25% to about 7.5% and most preferably from about 0.5% to about 5% by weight of composition, for example diethylenetriamine penta (methylene phosphonate), ethylenediamine tetra(methylene phosphonate) hexamethylenediamine tetra(methylene phosphonate), ethylene diphosphonate, hydroxy-ethylene-1,1-diphosphonate, nitrilotriacetate, ethylenediaminotetracetate, ethylenediamine-N,N′-disuccinate in their salt and free acid forms.

The compositions herein can contain a corrosion inhibitor such as organic silver coating agents in levels of from about 0.05% to about 10%, preferably from about 0.1% to about 5% by weight of composition (especially paraffins such as Winog 70 sold by Wintershall, Salzbergen, Germany), nitrogen-containing corrosion inhibitor compounds (for example benzotriazole and benzimadazole—see GB-A-1137741) and Mn(II) compounds, particularly Mn(II) salts of organic ligands in levels of from about 0.005% to about 5%, preferably from about 0.01% to about 1%, more preferably from about 0.02% to about 0.4% by weight of the composition.

Other suitable components herein include colorants, water-soluble bismuth compounds such as bismuth acetate and bismuth citrate at levels of from about 0.01% to about 5%, enzyme stabilizers such as calcium ion, boric acid, propylene glycol and chlorine bleach scavengers at levels of from about 0.01% to about 6%, lime soap dispersants (see WO-A-93/08877), suds suppressors (see WO-93/08876 and EP-A-0705324), polymeric dye transfer inhibiting agents, optical brighteners, perfumes, fillers and clay.

Capsule or Pouch Material

The capsules or pouches herein can be of any form which is suitable to hold the compositions, e.g. without allowing the substantial release of composition from the pouch prior to use. The exact execution will depend on, for example, the type and amount of the composition in the pouch, the number of compartments in the pouch, the characteristics required from the pouch to hold, protect and deliver or release the compositions.

The capsule or pouch is preferably made of a material which is soluble or dispersible in water, and has a water-solubility of at least 50%, preferably at least 75% or even at least 95%, as measured by the method set out here after using a glass-filter with a maximum pore size of 20 microns.

50 grams±0.1 gram of capsule or pouch material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the % solubility or dispersability can be calculated.

Preferred capsule, pouch and wrap materials are polymeric materials, preferably polymers which are formed into a film or sheet. The capsule or pouch and wrap material can, for example, be obtained by casting, blow-moulding, extrusion or blown extrusion of the polymeric material, as known in the art.

Preferred polymers, copolymers or derivatives thereof suitable for use as capsule, pouch and wrap material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%.

Mixtures of polymers can also be used. This may in particular be beneficial to control the mechanical and/or dissolution properties of the compartment or pouch, depending on the application thereof and the required needs. For example, it may be preferred that a mixture of polymers is present in the material of the compartment, whereby one polymer material has a higher water-solubility than another polymer material, and/or one polymer material has a higher mechanical strength than another polymer material. It may be preferred that a mixture of polymers is used, having different weight average molecular weights, for example a mixture of PVA or a copolymer thereof of a weight average molecular weight of 10,000-40,000, preferably around 20,000, and of PVA or copolymer thereof, with a weight average molecular weight of about 100,000 to 300,000, preferably around 150,000.

Also useful are polymer blend compositions, for example comprising hydrolytically degradable and water-soluble polymer blend such as polylactide and polyvinyl alcohol, achieved by the mixing of polylactide and polyvinyl alcohol, typically comprising 1-35% by weight polylactide and approximately from 65% to 99% by weight polyvinyl alcohol, if the material is to be water-dispersible, or water-soluble. It may be preferred that the PVA present in the film is from 60-98% hydrolysed, preferably 80% to 90%, to improve the dissolution of the material.

Most preferred pouch and wrap materials are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray.

The water-soluble film herein may comprise other additive ingredients than the polymer or polymer material. For example, it may be beneficial to add plasticisers, for example glycerol, ethylene glycol, diethyleneglycol, propylene glycol, sorbitol and mixtures thereof, additional water, disintegrating aids. It may be useful that the pouch or water-soluble film itself comprises a detergent additive to be delivered to the wash water, for example organic polymeric soil release agents, dispersants, dye transfer inhibitors.

Liquid, Paste or Gel Compositions

The systems of the present invention comprise at least one liquid, paste or gel detergent composition in a capsule or pouch although systems with more than one liquid, paste or gel compositions are also envisaged herein. Preferably the liquid, paste or gel component comprises ingredients that are either difficult or costly to include in a substantially solid composition or that are typically transported and supplied as liquid ingredients and which would require additional processing steps to enable them to be included in a substantially solid composition.

The capsules or pouches of the system of the present invention can comprise a variety of liquid, paste or gel compositions. The composition(s) preferably comprises less than 10%, preferably from 1% to 8%, more preferably from 2% to 7.5%, by weight, water. This is on basis of free water, added to the other ingredients of the composition.

The composition can be made by any method and can have any viscosity, typically depending on its ingredients. The liquid/gel compositions preferably have a viscosity of 50 to 10000 cps (centipoises), as measured at a rate of 20 s⁻¹, more preferably from 300 to 3000 cps or even from 400 to 600 cps. The compositions herein can be Newtonian or non-Newtonian. The liquid composition preferably has a density of 0.8 kg/1 to 1.3 kg/l, preferably around 1.0 to 1.1 kg/I.

In the compositions herein it is preferred that at least a surfactant is present. Preferably the composition comprises at least 0.5% by weight thereof of surfactant. Preferably the composition comprises nonionic surfactant.

Highly preferred for use in the liquid, paste or gel compositions are solvents. Examples of suitable solvents are alcohols, diols, monoamine derivatives, glycerol, glycols, polyalkylane glycols, such as polyethylene glycol. Highly preferred are mixtures of solvents, such as mixtures of alcohols, mixtures of diols and alcohols, mixtures. Highly preferred may be that (at least) an alcohol, diol, monoamine derivative and preferably even glycerol are present. The compositions are preferably concentrated liquids having preferably less than 50% or even less than 40% by weight of solvent, preferably less than 30% or even less than 20% or even less than 35% by weight. Preferably the solvent is present at a level of at least 5% or even at least 10% or even at least 15% by weight of the composition.

The composition can comprise a cyclic hydrotrope. Any suitable cyclic hydrotrope may be used. However, preferred hydrotropes are selected from salts of cumene sulphonate, xylene sulphonate, naphthalene sulphonate, p-toluene sulphonate, and mixtures thereof. Especially preferred are salts of cumene sulphonate. While the sodium form of the hydrotrope is preferred, the potassium, ammonium, alkanolammonium, and/or C₂-C₄ alkyl substituted ammonium forms can also be used.

The compositions herein may contain a C₅-C₂₀ polyol, preferably wherein at least two polar groups that are separated from each other by at least 5, preferably 6, carbon atoms. Particularly preferred C₅-C₂₀ polyols include 1,4 Cyclo Hexane Di Methanol, 1,6 Hexanediol, 1,7 Heptanediol, and mixtures thereof.

The compositions preferably comprise a water-soluble builder compound, typically present in detergent compositions at a level of from 1% to 60% by weight, preferably from 3% to 40% by weight, most preferably from 5% to 25% by weight of the composition.

Suitable water-soluble builder compounds include the water soluble monomeric carboxylates, or their acid forms, or homo or copolymeric polycarboxylic acids or their salts in which the polycarboxylic acid comprises at least two carboxylic radicals separated from each other by not more that two carbon atoms, and mixtures of any of the foregoing. Preferred builder compounds include citrate, tartrate, succinates, oxydissuccinates, carboxymethyloxysuccinate, nitrilotriacetate, and mixtures thereof.

Another preferred ingredient useful in the compositions herein is one or more enzymes. Suitable enzymes are described herein above.

Additional Ingredients

In addition to the ingredients mentioned above the present detergent systems can comprise a variety of other ingredients. Ingredients suitable for inclusion into detergent compositions will readily suggest themselves to the skilled formulator.

Another preferred additional ingredient is perfume. In the context of this specification, the term “perfume” means any odoriferous material or any material which acts as a malodour counteractant. In general, such materials are characterized by a vapour pressure greater than atmospheric pressure at ambient temperatures. The perfume or deodorant materials employed herein will most often be liquid at ambient temperatures, but also can be solids such as the various tamphoraceous perfumes known in the art. A wide variety of chemicals are known for perfumery uses, including materials such as aldehydes, ketones, esters and the like. More commonly, naturally occurring plant and animal oils and exudates comprising complex mixtures of various chemicals components are known for use as perfumes, and such materials can be used herein. The perfumes herein can be relatively simple in their composition or can comprise highly sophisticated, complex mixtures of natural and synthetic chemical components, all chosen to provide any desired odour.

The perfume component may comprise an encapsulate perfume, a properfume, neat perfume materials, and mixtures thereof.

### Film Wrap

The system subunits described hereinabove are packaged in a water-soluble film wrap. Water soluble materials suitable for flow wrapping herein can be the same as those used for the water-soluble pouch as described herein above.

The film wrap may be applied to the plurality of subunits in any suitable manner. Flow wrapping processes producing loose wraps around the plurality of subunits are suitable for use herein. Preferred for use herein are flow wrapping processes producing a tight wrap around the plurality of subunits, tight fitting wrap can for instance be achieved by using a heat-shrinkable film in combination with means for heat-shrinking the film or by using an elastic pre-stretched film or alternatively by simply tightly wrapping the pre-formed subunits. The film wrap can be formed from a single piece of water-soluble film or from separate pieces, i.e. bottom and lid.

A preferred flow wrapping process for use herein is horizontal pillow form process, using, for example, a HSM flow wrapping horizontal pillow machine available from Sig.

Once the system subunits are packaged in the film wrap they are preferably added to a secondary package before being shipped for sale. Such secondary packages are well-known in the art and are typically cartons. The film-wrapped products can be randomly packed in the secondary package or they can be arranged in an orderly manner.

### Method of Manufacturing

The detergent system of the invention can be manufactured by a process comprising the steps of:

a) forming a tablet;

b) forming a liquid, paste or gel water-soluble pouch; and

c) co-wrapping the pre-formed tablet and capsule or pouch in the water-soluble film wrap.

Preferably the subunit in the form of a tablet is formed as described herein above. The liquid, paste or gel capsule or pouch can be formed by vertical forming or horizontal thermal, vacuum or thermo-vacuum forming process. Preferably the tablet comprises a depression to accommodate the capsule or pouch, the capsule or pouch can be either secured to the tablet, for example by adhesive means or it can simply be seated on the tablet. The subunit combination is wrapped using a conventional automatic wrapping machine, preferably a horizontal pillow forming machine.

### Method of Cleaning

The present invention also relates to a method of cleaning dishware/tableware in an automatic washing machine using a detergent system comprising a plurality of pre-formed subunits wrapped in a water-soluble film wherein at least one of the subunits is a liquid, paste or gel-filled water-soluble capsule or pouch.

The method of the present invention provides the benefits having both a solid composition and a liquid, paste or gel composition. Therefore, cleaning efficacy is improved and costs are kept down.

Preferred solid detergent compositions in the form of a tablet and liquid, paste or gel-filled water-soluble capsule or pouch compositions for use in this method are described hereinabove.

### EXAMPLES

### Example 1

Liquid Pouch Preparation

The ingredients below were mixed together to form a homogenous liquid.

| | Weight % |
|---|---|
| Nonionic surfactant | 15.2 |
| Anionic surfactant | 22.7 |
| Fatty Acid | 15.1 |
| Propandiol | 15.1 |
| MEA | 8.4 |
| Polycarboxylate polymer | 6.8 |
| Chelants | 2.0 |
| Perfume | 2.3 |
| Water/Misc | 12.4 |

25 ml of the above mixture was made. A water-soluble pouch was then prepared by the following method.

A vacuum of 500 mbar was used to draw a layer of 76 micron Monosol M-8630 PVA film into a 5 cm diameter, 25 cc, square mould containing 5 vacuum ports arranged at the bottom of the mould. The mould was partially filled with 25 mls of the liquid mix. A second layer of 76 micron Monosol M-8630 PVA film was then placed over the first film and heat sealed at 155° C. for 1.0 seconds and 2000 kN/m². The excess film trim was then removed leaving a frill of 3-5 mm around the pouch.

Tablet Preparation

A granular powder composition as described below was prepared into a tablet form.

| | Weight % |
|---|---|
| Cationic surfactant | 2.0 |
| Anionic surfactant | 5.0 |
| Citric Acid & Citrate | 1.0 |
| Sodium tripolyphosphate | 30.0 |
| Chelants | 1.0 |
| Layered silicate | 5.0 |
| Percarbonate | 18.0 |
| TAED | 6.0 |
| Enzymes | 1.8 |
| Sodium Carbonate | 22.0 |
| Silicone suds suppressor | 1.5 |
| PEG | 2.3 |
| Water/Misc | 4.3 |

The materials listed above were mixed together. Then 42g of the mixture was introduced into a mould of square shape with a diameter of 4.5 cm and 3 cm depth, and compressed with a force of 5kN, using a single stroke press to give tablets of about 2.2 cm height and a density of about 1.1 g./cc.

The tablet and pouch were then combined together by placing them in close proximity to each other on the guide track of a flow-wrapping machine. Suitable equipment is supplied by Sig. The tablet and pouch were then wrapped together in one package using Monosol M-8630 PVA film.

### Examples 2-5

| Example | 2 | 3 | 4 | 5 |
|---|---|---|---|---|
| Tablet composition | | | | |
| C₁₄AO | 5.55 | 5.55 | | |
| C₁₆AO | | | 5.55 | 5.55 |
| ACNI | 5.55 | 5.55 | | |
| SLF18 | | | 5.55 | 5.55 |
| STPP (anhydrous) | 21.0 | 21.0 | 21.0 | 21.0 |
| STPP (hydrated) | 31.5 | 31.5 | 31.5 | 31.5 |
| HEDP | 1.0 | 1.0 | 1.0 | 1.0 |
| Savinase | 0.7 | 0.7 | 0.7 | 0.7 |
| Termamyl | 0.7 | 0.7 | 0.7 | 0.7 |
| Perborate | | 13.55 | | 13.55 |
| Percarbonate | 13.55 | | 13.55 | |
| Carbonate | 15.0 | 10.0 | 15.0 | 15.0 |
| Silicate | 5.0 | 10.0 | 5.0 | 5.0 |
| Perfume | 0.5 | 0.5 | 0.5 | 0.5 |
| Liquid composition | | | | |
| DPG | 98.5 | 95.0 | 95.0 | 99.5 |
| FN3 Liquid | | 1.40 | 2.4 | |
| Duramyl Liquid | | 2.0 | 2.4 | |
| Non-ionic | 1.0 | 1.2 | | |
| Dye | 0.5 | 0.4 | 0.2 | 0.5 |

The tablets are prepared from particulate detergent compositions as follows. The detergent compositions are prepared by admixing the components and the mixtures are then passed into the die of a conventional rotary press. The press includes a punch suitably shaped for forming a mould in the upper surface of the tablet. The cross-section of the die is approximately 30×38 mm. The compositions are then subjected to a compression force of 940 kg/cm², the punch is elevated, and tablets comprising the mould are ejected from the tablet press.

Separately, PVA pouches are formed and filled with the liquid compositions of examples 2 to 5.

The tablets and pouches are combined together by placing them in close proximity to each other on the guide track of a HSM horizontal pillow flow-wrapping machine supplied by Sig. The tablets and pouches are then wrapped together in a single package using Monosol M-8630 PVA film.

1. A detergent system in unit-dose form comprising a plurality of pre-formed subunits wherein at least one of the subunits is selected from the group consisting of liquid, paste and gel-filled water-soluble capsules and pouches and wherein the subunits are packaged together in a water-soluble film wrap.

2. A detergent system according to claim 1 wherein at least one of the subunits is a solid composition in the form of a tablet comprising an ingredient selected from the group consisting of builders, bleaching systems, enzymes and mixtures thereof.

3. A detergent system according to claim 2 wherein both the solid and the liquid, paste or gel composition comprise at least one non-ionic surfactant and wherein the liquid, paste or gel composition comprises at least 0.5% by weight thereof of non-ionic surfactant.

4. A detergent system according to claim 3 wherein the wrap material is polyvinyl alcohol.

5. A method of making a detergent system in unit dose form comprising a plurality of pre-formed subunits comprising the steps of:
a. forming a tablet;
b. forming a liquid, paste or gel-filled water-soluble capsule or pouch; and
c. co-wrapping the pre-formed tablet and capsule or pouch in a water-soluble wrapper.

6. A method according to claim 5 wherein the tablet comprises a depression within which the capsule or pouch is placed prior to co-wrapping.

7. A method of cleaning dishware/tableware in an automatic dishwashing machine comprising adding to the dishwashing machine a detergent system in unit dose form comprising a plurality of pre-formed subunits wherein at least one of the subunits is selected from the group consisting of liquid, paste and gel-filled water-soluble capsules and pouches and wherein the subunits are packed together in a water-soluble film wrap.
